(19) United States
(12) Patent Application Publication
(10) Pub. No.: US 2025/0054317 A1
(43) Pub. Date: Feb. 13, 2025

(54) VEHICLE CONTROL SYSTEM

(71) Applicant: HITACHI ASTEMO, LTD., Hitachinaka-shi, Ibaraki (JP)

(72) Inventor: Takaya ISHII, Chiyoda-ku, Tokyo (JP)

(73) Assignee: HITACHI ASTEMO, LTD., Hitachinaka-shi, Ibaraki (JP)

(21) Appl. No.: 18/718,100

(22) PCT Filed: Jul. 25, 2022
(86) PCT No.: PCT/JP2022/028589

§ 371 Date: Jun. 10, 2024

(30) Foreign Application Priority Data
Jan. 5, 2022 (JP) 2022-000335

(51) Int. Cl. G06V 20/58; G06V 10/776; G08G 1/0967

(52) U.S. Cl. CPC G06V 20/584; G06V 10/776; G08G 1/0967; G06V 2201/08

(57) ABSTRACT

Provided is a vehicle control system which prevents a host vehicle from being controlled by executing a driving support function based on an erroneous lighting state in a case where the lighting state of a traffic light is erroneously determined. The vehicle control system includes: a lighting state determination unit 123 which determines a lighting state of a traffic light placed on a road on which a host vehicle travels, and calculates reliability of the determined lighting state of the traffic light, a dynamic object recognition unit 122 which recognizes information regarding a dynamic object existing around the host vehicle (behavior of another vehicle, a pedestrian, or the like), and a lighting state evaluation unit 131 which updates the reliability of the lighting state calculated by the lighting state determination unit 123 based on the information recognized by the dynamic object recognition unit 122 (information regarding the dynamic object existing around the host vehicle).

### TECHNICAL FIELD

The present invention relates to a vehicle control system which controls traveling of a host vehicle based on a lighting state of a traffic light.

### BACKGROUND ART

In recent years, in a vehicle such as an automobile, as a technique of driving support including automatic driving, a technique of follow-up traveling control has been developed in which a host vehicle is controlled to travel following a target course or a preceding vehicle. In a case where the follow-up traveling is automatically performed, it is necessary to accurately determine a lighting state of a traffic light at a point where the traffic light is placed, such as an intersection, and to perform control so that the host vehicle can safely stop, start, and pass.

Therefore, a technique for determining the lighting state of a traffic light with high accuracy based on a captured image obtained by an in-vehicle camera or the like has been considered (see, for example, PTL 1). In addition, a vehicle travel control system capable of ensuring safety even when the lighting state of a traffic light cannot be grasped due to a weather condition such as snowstorm, dense fog, or heavy rain has been considered (see, for example, PTL 2).

### CITATION LIST

### Patent Literature

PTL 1: JP 2017-130163 A
PTL 2: JP 2018-173723 A

### SUMMARY OF INVENTION

### Technical Problem

However, since only the captured image is input in the method for determining the lighting state of the traffic light described in PTL 1, for example, in a case where a large amount of noise is included in the captured image due to the presence of another light emitting source or the like, it is considered that the lighting state of the traffic light cannot be correctly determined and may be erroneously determined in some cases. At this time, since the lighting state of the traffic light is detected even if it is erroneously determined, for example, in the travel control system described in PTL 2, the host vehicle is controlled according to the erroneously determined lighting state, and it is considered that safety cannot be secured.

On the other hand, there are many cases where dynamic objects such as other vehicles and pedestrians exist around the host vehicle. These dynamic objects can be detected by sensors such as radar and lidar in addition to the in-vehicle camera, and their behavior can be observed without depending on the captured image. In addition, the dynamic objects around the host vehicle change its behavior depending on the lighting state of the same traffic light as the traffic light for the host vehicle. Therefore, it is considered that by observing the behavior of the dynamic objects around the host vehicle, the lighting state of the traffic light for the host vehicle can be predicted, and whether the lighting state of the traffic light determined from the captured image is reliable can be evaluated.

In view of the above, an object of the present invention is to provide a vehicle control system which, when controlling a host vehicle, observes a dynamic object existing around the host vehicle and evaluates a determination result of a lighting state of a traffic light based on a behavior of the dynamic object, instead of using the determination result of the lighting state of the traffic light obtained from a captured image as it is, thereby preventing the host vehicle from being controlled in accordance with an erroneous determination result.

### Solution to Problem

In order to achieve the above object, the present invention includes: a lighting state determination unit which determines a lighting state of a traffic light placed on a road on which a host vehicle travels and calculates reliability of the determined lighting state of the traffic light; a dynamic object recognition unit which recognizes information regarding a dynamic object existing around the host vehicle; and a lighting state evaluation unit which updates the reliability of the lighting state calculated by the lighting state determination unit based on the information recognized by the dynamic object recognition unit.

### Advantageous Effects of Invention

According to the present invention, the determination result of the lighting state of the traffic light obtained from the captured image can be evaluated based on the behavior of the dynamic object existing around the host vehicle. As a result, it is possible to provide a vehicle control system capable of preventing the host vehicle from being controlled according to an erroneous determination result and ensuring safety even in a case where the captured image contains a large amount of noise and an erroneous lighting state is determined.

The problems, configurations, and effects other than those described above will be clarified by the following description of embodiments.

### BRIEF DESCRIPTION OF DRAWINGS

FIG. 1 is an example of a functional block diagram of a vehicle control system to which the present invention is applied.

FIG. 2 is a flowchart illustrating a flow of characteristic processing when determining a lighting state of a traffic light.

FIG. 3 is an image of processing contents in step S105 of the flowchart shown in FIG. 2.

FIG. 4 is a diagram illustrating an example of a result of determining a lighting state of a traffic light.

FIG. 5 is a diagram illustrating an intersection with a traffic light.

FIG. 6 is a flowchart illustrating a flow of characteristic processing when evaluating a lighting state of a traffic light.

FIG. 7A is an example of a probability distribution table in which behaviors of parallel traveling vehicles with respect to a lighting state of a traffic light are organized.

FIG. 7B is an example of a probability distribution table in which behaviors of intersecting vehicles with respect to a lighting state of a traffic light are organized.

FIG. 8A is an example of a result of updating reliability of a lighting state of a traffic light based on behaviors of parallel traveling vehicles.

FIG. 8B is an example of a result of updating the reliability of a lighting state of a traffic light based on behaviors of parallel traveling vehicles and intersecting vehicles.

FIG. 9 is an example of a result of calculating a divergence degree between reliability before update and reliability after update.

### DESCRIPTION OF EMBODIMENTS

Hereinafter, embodiments of the present invention will be described with reference to the drawings.

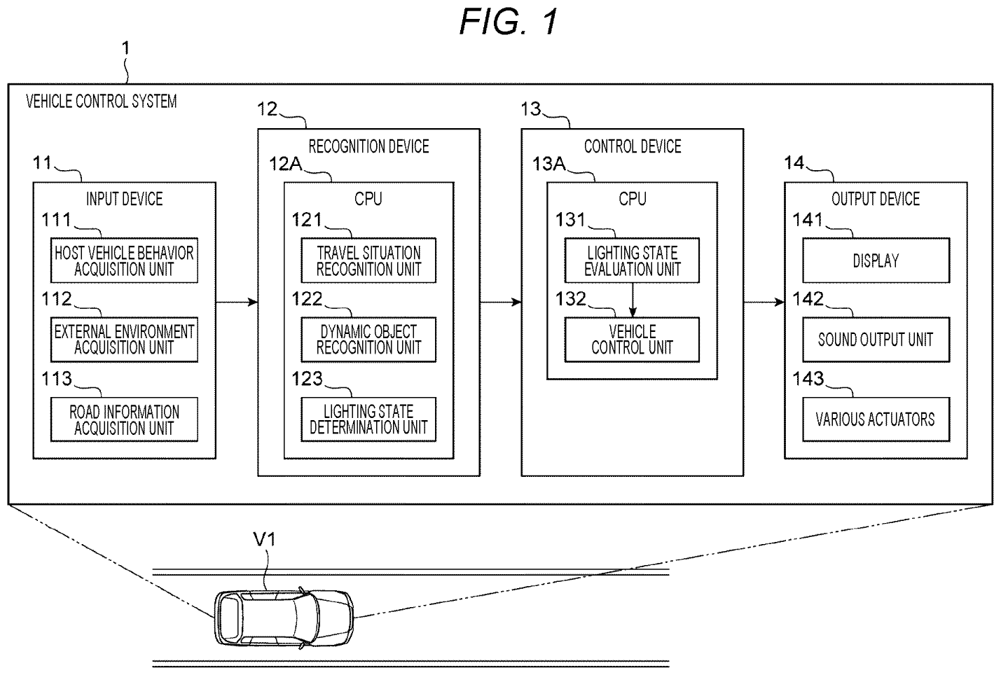

FIG. 1 is a functional block diagram of a vehicle control system to which the present invention is applied. A vehicle control system 1 illustrated in FIG. 1 is mounted on a vehicle (host vehicle) V1, and performs travel control of the vehicle V1. The vehicle control system 1 illustrated in FIG. 1 can cause the vehicle V1 to automatically travel to a preset target point or can assist a driver in driving.

As illustrated in FIG. 1, the vehicle control system 1 includes an input device 11, a recognition device 12, a control device 13, and an output device 14.

The input device 11 includes, for example, a host vehicle behavior acquisition unit 111, an external environment acquisition unit 112, and a road information acquisition unit 113. The input device 11 is connected to the recognition device 12, and outputs information acquired by the host vehicle behavior acquisition unit 111, the external environment acquisition unit 112, and the road information acquisition unit 113 to the recognition device 12.

The host vehicle behavior acquisition unit 111 acquires information regarding physical behavior such as a position, speed, and acceleration of the host vehicle V1. As the host vehicle behavior acquisition unit 111, for example, a receiving device of a global navigation satellite system (GNSS), or an internal sensor such as a gyro sensor, an acceleration sensor, or a wheel speed sensor (all not illustrated) is used.

The external environment acquisition unit 112 acquires information regarding objects around the host vehicle V1, road marks (road marking paint) such as white lines and stop lines on the road, and information regarding environment around the host vehicle V1 such as traffic lights and speed signs existing around the road. As the external environment acquisition unit 112, for example, an external sensor such as a camera, a 77-GHz radar, a 24-GHz radar, a short range lidar, a long range lidar, or a sonar sensor (all not illustrated) is used.

The road information acquisition unit 113 acquires, for example, road network information including nodes and links, traffic rule information, and traffic safety facility information. The road network information includes road structure information such as node detailed information (cross, T-junction, etc.) and link detailed information (number of lanes, shape, etc.). The traffic rule information refers to a concept including not only traffic regulations but also traffic manners commonly shared. The traffic safety facility information refers to equipment intended to be visually recognized by a driver for traffic safety, such as traffic lights and road signs. The road information acquisition unit 113 may acquire the road information from a storage medium which stores the road information as necessary, or may acquire the road information from a server on a network as necessary.

The recognition device 12 is connected to the input device 11, and creates information necessary for controlling traveling of a vehicle based on various types of information input from the input device 11. The recognition device 12 mainly includes a computer including a CPU 12A. The CPU 12A includes, for example, a travel situation recognition unit 121, a dynamic object recognition unit 122, and a lighting state determination unit 123. The recognition device 12 is connected to the control device 13, and outputs information created by the travel situation recognition unit 121, the dynamic object recognition unit 122, and the lighting state determination unit 123 to the control device 13.

The travel situation recognition unit 121 recognizes the lane on which the host vehicle V1 is traveling and updates position information of the host vehicle V1 by using, for example, position information acquired by the host vehicle behavior acquisition unit 111, white line information acquired by the external environment acquisition unit 112, and the road information acquired by the road information acquisition unit 113.

For example, the dynamic object recognition unit 122 recognizes the presence of other vehicles or pedestrians (hereinafter, may be referred to as dynamic objects) and calculates the travel direction and speed of the dynamic objects using speed information of the host vehicle V1 acquired by the host vehicle behavior acquisition unit 111 and information of object existing around the host vehicle V1 acquired by the external environment acquisition unit 112. Further, by combining with the road information acquired by the road information acquisition unit 113, position information on the road where the dynamic objects exist is acquired. Thereby, road traffic information indicating, for example, that the recognized dynamic object is a parallel traveling vehicle traveling in a lane adjacent to its own lane, a stopped vehicle stopped in a lane adjacent to its own lane, an intersecting vehicle orthogonal to an intersection (traveling in a lane intersecting its own lane), a stopped vehicle stopped at an intersection, a pedestrian present at an intersection, or a pedestrian crossing a crosswalk is created. In addition, predicted behavior information indicating, for example, that the parallel traveling vehicle or the intersecting vehicle is about to stop before the stop line, or the parallel traveling vehicle or the intersecting vehicle is about to enter the intersection without stopping before the stop line is created by using time series data of the dynamic objects.

For example, the lighting state determination unit 123 determines a lighting state of a traffic light (that is, a traffic light placed on a road on which the host vehicle V1 travels) for the host vehicle V1 based on an image captured by an in-vehicle camera used as the external environment acquisition unit 112. The lighting state described herein indicates, in addition to a general red light, yellow light, and green light, any one or a combination of the presence or absence of display of an arrow signal, a direction, and a flashing state of a red light.

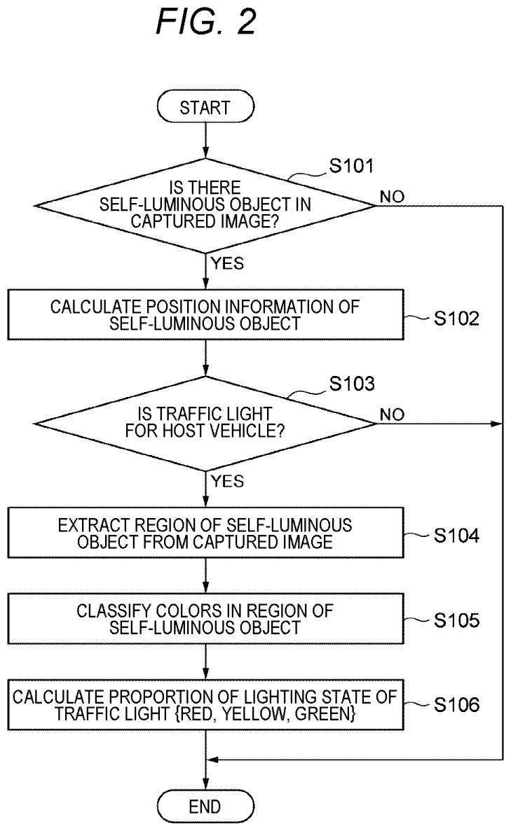

A method for determining a lighting state of a traffic light for the host vehicle V1 will be described with reference to FIG. 2. FIG. 2 is a flowchart illustrating a characteristic processing flow when the lighting state determination unit 123 determines the lighting state of a traffic light for the host vehicle V1. In addition, in the flowchart illustrated in FIG. 2, for the sake of simplicity, the lighting state of a target traffic light includes only a red light, a yellow light, and a green light.

In step S101, the lighting state determination unit 123 determines whether there is a self-luminous object in the captured image acquired by the external environment acquisition unit 112. In a case where it is determined that there is a self-luminous object, step S102 is executed. In a case where it is determined that there is no self-luminous object, it is determined that no traffic light is detected, and the processing ends.

In step S102, the lighting state determination unit 123 calculates position information of the self-luminous object. Since the position information obtained from the captured image is a relative position with respect to the host vehicle position, absolute position information of the self-luminous object is calculated by combining with absolute position information of the host vehicle calculated by the travel situation recognition unit 121. In a case where a plurality of self-luminous objects are detected in the captured image, position information is calculated for all the self-luminous objects.

In step S103, the lighting state determination unit 123 collates the absolute position information of the self-luminous object with the road information obtained from the road information acquisition unit 113 to determine whether the self-luminous object is a traffic light for the host vehicle V1. In a case where a plurality of self-luminous objects are detected, determination processing is executed on all the self-luminous objects. In a case where there is one or more self-luminous objects determined to be the traffic light for host vehicle V1, step S104 is executed. Otherwise, it is determined that no traffic light has been detected, and the processing ends.

In step S104, the lighting state determination unit 123 extracts a region of the self-luminous object (self-luminous region) determined to be the traffic light for the host vehicle V1 from the captured image acquired by the external environment acquisition unit 112. Thereafter, in step S105, the lighting state determination unit 123 classifies colors included in the extracted region of the self-luminous object for each pixel. Finally, in step S106, the lighting state determination unit 123 calculates a proportion of {Red, Yellow, Green} included in the region of the self-luminous object from the classified result.

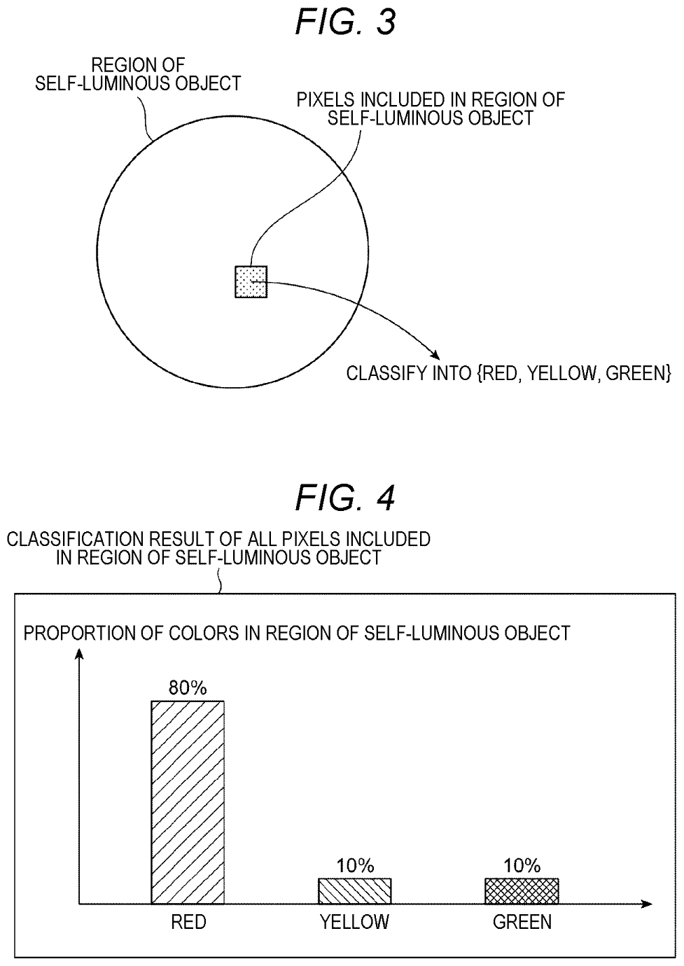

FIG. 3 is an image of processing contents performed in step S105 of the flowchart illustrated in FIG. 2. As illustrated in FIG. 3, the lighting state determination unit 123 scans all pixels included in the region of the self-luminous object and classifies the pixels as {Red, Yellow, Green}. At this time, a pixel that does not belong to any color is not included in the classification result as not applicable.

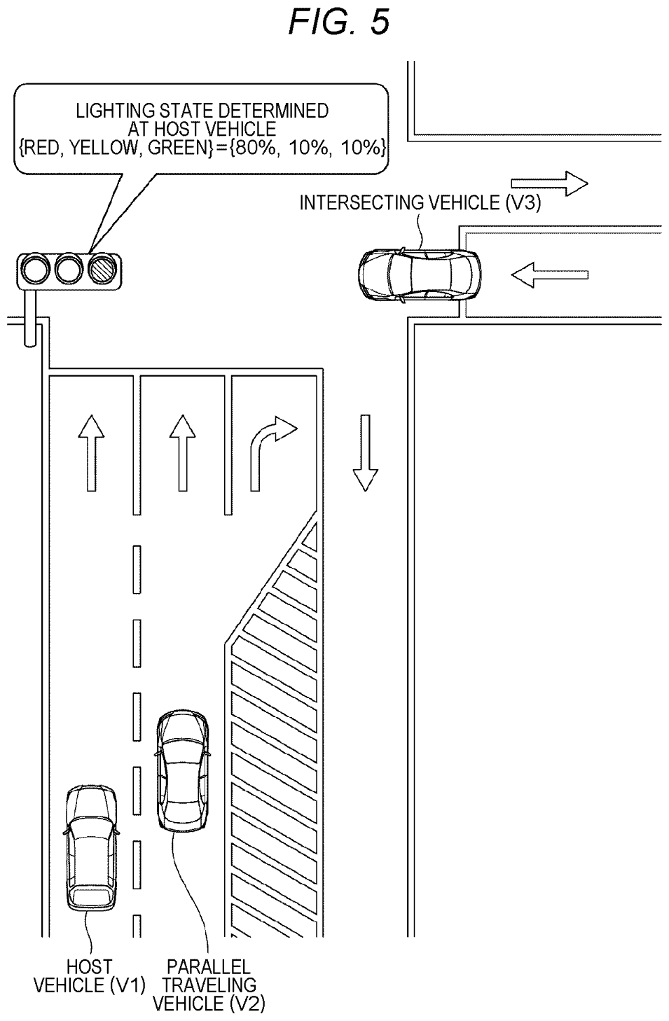

FIG. 4 is an example of a result of determining the lighting state of the traffic light according to the determination method illustrated in FIG. 2. The result shown in FIG. 4 indicates that a self-luminous object can be detected from the captured image, and the proportion of each of {Red, Yellow, Green} included in the region of the self-luminous object is {80%, 10%, 10%}.

Based on the classification result as illustrated in FIG. 4, the lighting state determination unit 123 determines the lighting state in which the proportion is greater than or equal to a reference value (for example, 75%) as the lighting state of the traffic light for the host vehicle V1 and externally outputs the lighting state. In addition, the proportion of color included in the region of the self-luminous object as illustrated in FIG. 4 is externally output as a reliability of the lighting state of the traffic light. In a case where the proportion of all the lighting states is less than the reference value, that is, in a case where there is ambiguity, it is determined that no traffic light has been detected, and the processing ends.

In addition to the processing illustrated in FIG. 2, for example, a classifier may be formed by a machine learning model using a neural network, and the lighting state of the traffic light for the host vehicle V1 may be determined by inference based on a machine learning method. In this case, the color corresponding to the output value having the largest value among the output values from the output layer of the neural network is determined as the lighting state of the traffic light, and the output value itself from the output layer is treated as the reliability of the lighting state of the traffic light.

The control device 13 performs information processing related to travel control of the host vehicle using various types of information output from the input device 11 and the recognition device 12. The control device 13 mainly includes a computer including a CPU 13A. The CPU 13A includes, for example, a lighting state evaluation unit 131 and a vehicle control unit 132. The control device 13 is connected to the output device 14, and outputs information created by the lighting state evaluation unit 131 and the vehicle control unit 132 to the output device 14.

The lighting state evaluation unit 131 uses, for example, information of dynamic object such as other vehicles and pedestrians output from the dynamic object recognition unit 122 to evaluate whether the lighting state of the traffic light output from the lighting state determination unit 123 is reliable (details will be described later). The information of the dynamic object here includes, in addition to simple position information and speed information of the dynamic object, road traffic information, for example, that a parallel traveling vehicle or an intersecting vehicle is entering an intersection, a parallel traveling vehicle or an intersecting vehicle stops at a stop line, a pedestrian exists at an intersection, and a pedestrian is crossing a crosswalk. In addition, the information of the dynamic object also includes predicted behavior information indicating that a parallel traveling vehicle or an intersecting vehicle is about to stop before a stop line, or a parallel traveling vehicle or an intersecting vehicle is about to enter an intersection.

The vehicle control unit 132 calculates a control command value for controlling traveling of the host vehicle V1 by using various types of information output from the input device 11, the recognition device 12, and the lighting state evaluation unit 131, and outputs the control command value to the output device 14. The control command value here includes not only control information for changing a physical state such as running, turning, or stopping of the vehicle via various actuators 143, but also signal information for providing information to the driver via a display 141 (a meter or the like) or a sound output device 142 (a speaker or the like).

As illustrated in FIG. 1, the output device 14 includes the display 141, the sound output device 142, and various actuators 143. The output device 14 is connected to the control device 13, and controls the display 141, the sound output device 142, and the various actuators 143 in response to a control command value output from the control device 13.

The display 141 provides various types of information, for example, operation information of the driving support function as visual information to occupants of the vehicle including a driver. The display 141 is, for example, an instrument panel, a display, or the like disposed in the vicinity of the driver's seat of the vehicle. The display may be a head-up display. Alternatively, a mobile phone held by the occupant, a portable information terminal including a so-called smartphone, a tablet personal computer, or the like may be used as a part or all of the display 141.

The sound output device 142 provides various types of information, for example, operation information of the driving support function as auditory information to occupants of the vehicle including the driver. The sound output device 142 is, for example, a speaker disposed in the vicinity of the driver's seat of the vehicle. Alternatively, a speaker mounted on a mobile phone held by an occupant, a portable information terminal including a so-called smartphone, or a tablet personal computer may be used as a part or all of the sound output device 142.

The various actuators 143 change a steering angle, acceleration/deceleration, and a braking pressure of the vehicle based on a control command value input from the control device 13.

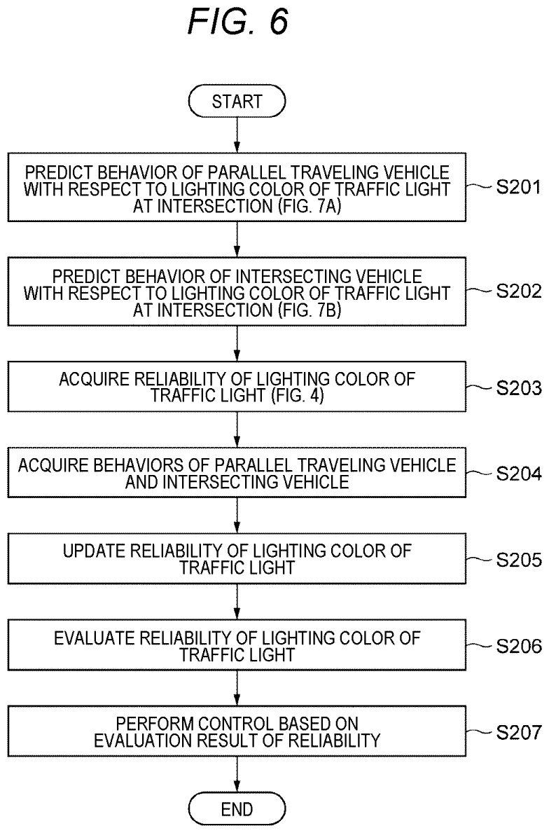

FIG. 5 is a diagram illustrating a state in which host vehicle V1 on which vehicle control system 1 illustrated in FIG. 1 is mounted is approaching an intersection where a traffic light is located. In this example, it is assumed that the host vehicle V1 observes a parallel traveling vehicle V2 and an intersecting vehicle V3, and the dynamic object recognition unit 122 can recognize their behaviors. In addition, it is assumed that the host vehicle V1 detects a traffic light for the host vehicle V1, and the lighting state determination unit 123 determines the lighting state of the traffic light as a red light, and the reliability as {Red, Yellow, Green}={80%, 10%, 10%}.

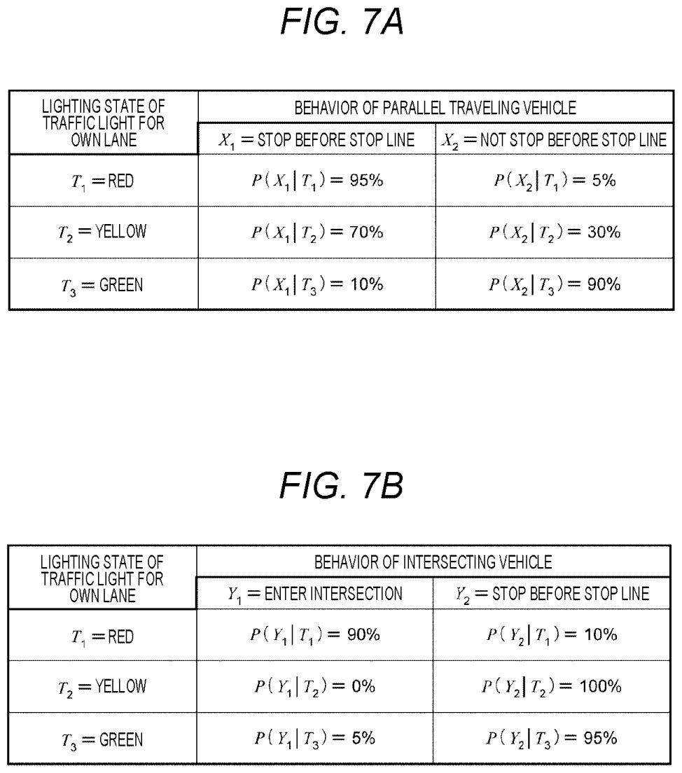

An operation when the vehicle control system 1 illustrated in FIG. 1 evaluates the lighting state of a traffic light will be described with reference to FIG. 6. FIG. 6 is a flowchart illustrating a characteristic processing flow when the vehicle control system 1 illustrated in FIG. 1 evaluates the lighting state of a traffic light at an intersection with the traffic light as illustrated in FIG. 5. The flowchart illustrated in FIG. 6 is performed regularly (periodically) in this example, but the processing may be started, for example, when approaching an intersection where a traffic light is located, when a traffic light placed at an intersection is detected, or the like.

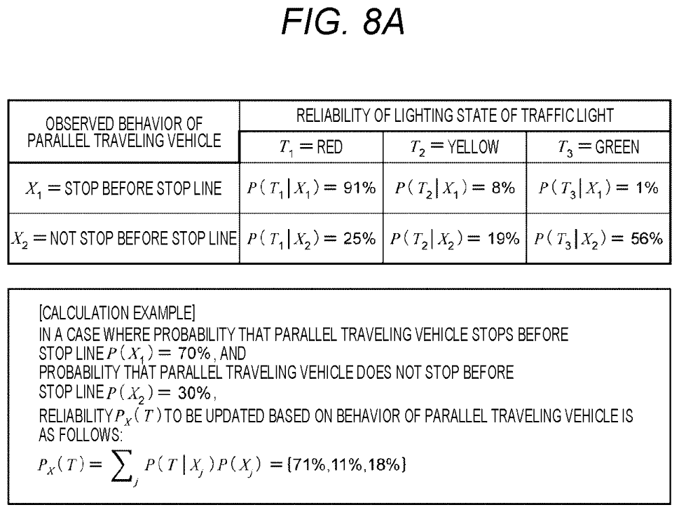

In step S201, the lighting state evaluation unit 131 predicts the behavior of a parallel traveling vehicle with respect to the lighting state of the traffic light at an intersection. Specifically, a probability distribution table as illustrated in FIG. 7A is read. The probability distribution table illustrated in FIG. 7A is a probability distribution table representing a behavior prediction of a parallel traveling vehicle (dynamic object) according to the lighting state of the traffic light at the intersection by probability, and is a table in which the lighting state of the traffic light for the own lane and the probability of whether the parallel traveling vehicle stops before the stop line for each lighting state are set in advance by a designer. For example, when the traffic light for the own lane is a red light, it indicates that the probability that the parallel traveling vehicle will stop before the stop line is 95%, and the probability that the vehicle will not stop is 5%. The probability distribution table illustrated in FIG. 7A is desirably set by statistics of road traffic conditions for each intersection.

In the probability distribution table illustrated in FIG. 7A, the behavior of the parallel traveling vehicle with respect to three patterns of red, yellow, and green as the lighting state of the traffic light is set, but the behavior of the parallel traveling vehicle with respect to a pattern such as an arrow signal or red flashing may be set. In addition, two patterns of stopping before the stop line and not stopping are set as the behavior of the parallel traveling vehicle, but the patterns are not limited thereto, and any pattern that can be taken by the parallel traveling vehicle can be set. However, it is desirable that the behavior of the parallel traveling vehicle set at this time can be appropriately observed by the host vehicle. In addition, the probability value to be set may be a fixed value, or may be a function of the speed of the parallel traveling vehicle or the distance to the stop line.

In step S202, lighting state evaluation unit 131 predicts the behavior of an intersecting vehicle with respect to the lighting state of the traffic light at the intersection illustrated in FIG. 5. Specifically, a probability distribution table as illustrated in FIG. 7B is read. The probability distribution table illustrated in FIG. 7B is a probability distribution table in which the behavior prediction of an intersecting vehicle (dynamic object) according to the lighting state of the traffic light at the intersection is expressed by probability, and is a table in which the lighting state of the traffic light for the own lane and the probability of whether the intersecting vehicle stops before the stop line for each lighting state are set in advance by the designer. For example, when the traffic light for the own lane is a red light, it indicates that the probability that the intersecting vehicle will enter the intersection is 90%, and the probability that the intersecting vehicle will stop at a stop line is 10%, since the traffic light for the intersecting vehicle is a green light. The probability distribution table illustrated in FIG. 7B is desirably set by statistics of road traffic conditions for each intersection.

Similarly to FIG. 7A, FIG. 7B may set the behavior of the intersecting vehicle with respect to a pattern such as an arrow signal or red flashing as the lighting state of the traffic light. In addition, patterns that can be taken by the intersecting vehicle can be added or changed. However, it is desirable that the behavior of the intersecting vehicle set at this time can be appropriately observed by the host vehicle. In addition, the probability value to be set may be a fixed value, or may be a function of the speed of the intersecting vehicle or the distance to the stop line.

In step S203, the lighting state evaluation unit 131 acquires the reliability of the lighting state of the traffic light for the host vehicle from the lighting state determination unit 123. In the example of the intersection illustrated in FIG. 4, the lighting state evaluation unit 131 acquires {Red, Yellow, Green}={80%, 10%, 10%} as the reliability from the lighting state determination unit 123.

In step S204, the lighting state evaluation unit 131 acquires information on the parallel traveling vehicle and the intersecting vehicle from the dynamic object recognition unit 122. Specifically, predicted behavior information indicating that the parallel traveling vehicle set in FIG. 7A is about to stop or not before the stop line is acquired. In addition, road traffic information indicating that the intersecting vehicle set in FIG. 7B enters the intersection or stops at the stop line is acquired.

In a case where the dynamic object recognition unit 122 performs behavior prediction, in a case where the behavior cannot be clearly predicted, a probability of occurrence of each behavior is acquired. For example, when the parallel traveling vehicle is decelerating but the predicted stop point calculated from the deceleration exceeds the stop line, values such as a probability of stopping before the stop line of 70% and a probability of not stopping before the stop line of 30% are acquired.

In step S205, the lighting state evaluation unit 131 first updates the reliability of the lighting state of the traffic light based on the behavior of the parallel traveling vehicle. Specifically, using Bayes' theorem, the calculation is performed by the following equation [Equation 1].

$$P ( {T}_{i} \vert {X}_{j} ) = \frac{P ( {X}_{j} \vert {T}_{i} ) P ( {T}_{i} )}{{\sum }_{i} P ( {X}_{j} \vert {T}_{i} ) P ( {T}_{i} )} \qquad [ Equation 1 ]$$

Here, T is a pattern of a lighting state of a traffic light, and {T₁=red, T₂=yellow, T₃=green} each is an element in the example illustrated in FIG. 7A. X is a pattern of behavior of the parallel traveling vehicle, and {X₁=stop before stop line, X₂=not stop before stop line} each is an element in the example illustrated in FIG. 7A. Further, P(Tᵢ) is the reliability when the lighting state of the traffic light is Tᵢ, and is {P(T₁)=80%, P(T₂)=10%, P(T₃)=10%} in the example illustrated in FIG. 5. P(Xⱼ|Tᵢ) is a probability that the parallel traveling vehicle performs behavior Xⱼ when the lighting state of the traffic light is Tᵢ, and that is indicated by the probability distribution illustrated in FIG. 7A.

P(Tᵢ|Xⱼ) calculated from the above equation [Equation 1] represents the probability that the lighting state of the traffic light is Tᵢ when the behavior of the parallel traveling vehicle is observed as Xⱼ.

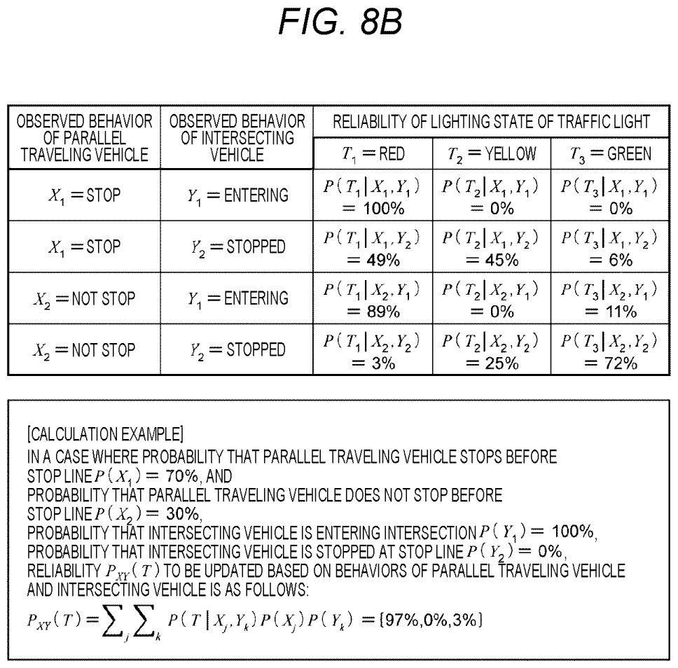

FIG. 8A illustrates a result of calculating P(Tᵢ|Xⱼ) for each pattern. For example, in a case the dynamic object recognition unit 122 observes that the parallel traveling vehicle stops before the stop line, the possibility that the lighting state of the traffic light for the host vehicle is red is 91%, and it can be said that the possibility of the red light is higher than the reliability of red=80% before the update. On the other hand, in FIG. 8A, when it is observed that the parallel traveling vehicle does not stop before the stop line, the possibility that the lighting state of the traffic light for the host vehicle is red has decreased to 25% (from red=80% before update), and it can be considered that the determination result of the lighting state determination unit 123 may be an error.

FIG. 8A also illustrates an example of a case where the behavior of the parallel traveling vehicle observed by the dynamic object recognition unit 122 is expressed by probability. Assuming that the probability that the parallel traveling vehicle stops before the stop line is P(X₁) and the probability that the parallel traveling vehicle does not stop before the stop line is P(X₂), the reliability of the lighting state of the traffic light can be calculated by the following equation [Equation 2]. Here, P_{X}(Tᵢ) is the reliability of the lighting state of the traffic light updated based on the behavior of the parallel traveling vehicle.

$${P}_{X} ( {T}_{i} ) = {\sum }_{j} P ( {T}_{i} \vert {X}_{j} ) P ( {X}_{j} ) \qquad [ Equation 2 ]$$

For example, when P(X₁)=70%, and P (X₂)=30%, P_{X}(Tᵢ)=71% is obtained, and it can be said that the possibility of the red signal is slightly lower than red=80% before the update.

In step S205, the lighting state evaluation unit 131 further updates the reliability of the lighting state of the traffic light based on the behavior of the intersecting vehicle. Specifically, using Bayes' theorem, the calculation is performed by the following equation [Equation 3].

$$P ( {T}_{i} \vert {X}_{j} , {Y}_{k} ) = \frac{P ( {Y}_{k} \vert {T}_{i} ) P ( {T}_{i} \vert {X}_{j} )}{{\sum }_{i} P ( {Y}_{k} \vert {T}_{i} ) P ( {T}_{i} \vert {X}_{j} )} \qquad [ Equation 3 ]$$

Here, Y is a pattern of behavior of an intersecting vehicle, and {Y₁=enter intersection, Y₂=stop at stop line} each is an element in the example illustrated in FIG. 7B. In addition, P(Yₖ|Tᵢ) is a probability that the intersecting vehicle performs behavior Yₖ when the lighting state of the traffic light is Tᵢ, and that is indicated by the probability distribution illustrated in FIG. 7B.

P(Tᵢ|Xⱼ, Yₖ) calculated from the above equation [Equation 3] represents a probability that the lighting state of the traffic light is Tᵢ when the behavior of the parallel traveling vehicle is observed as Xⱼ, and the behavior of the intersecting vehicle is observed as Yₖ.

FIG. 8B illustrates a result of calculating P(Tᵢ|Xⱼ, Yₖ) for each pattern. For example, in a case where the dynamic object recognition unit 122 observes that the parallel traveling vehicle stops before the stop line, and observes that the intersecting vehicle is entering the intersection, the possibility that the lighting state of the traffic light for the host vehicle is red is 100%, and it is considered that the traffic light is almost certainly a red light as compared with the reliability of red=80% before the update. On the other hand, in FIG. 8B, when it is observed that the parallel traveling vehicle does not stop before the stop line and it is observed that the intersecting vehicle has stopped at the stop line, the possibility that the lighting state of the traffic light for the host vehicle is red has decreased to 3% (from red=80% before updating), and it can be considered that the determination result of the lighting state determination unit 123 is an error with a high probability.

FIG. 8B also illustrates an example of a case where behaviors of the parallel traveling vehicle and the intersecting vehicle observed by the dynamic object recognition unit 122 are expressed by probabilities. Assuming that the probability that the parallel traveling vehicle stops before the stop line is P(X₁), the probability that the parallel traveling vehicle does not stop before the stop line is P(X₂), the probability that the intersecting vehicle is entering the intersection is P(Y₁), and the probability that the intersecting vehicle is stopped at the stop line is P(Y₂), the reliability of the lighting state of the traffic light can be calculated by the following equation [Equation 4]. Here, P_{XY}(Tᵢ) is the reliability of the lighting state of the traffic light updated based on the behaviors of the parallel traveling vehicle and the intersecting vehicle.

$${P}_{XY} ( {T}_{i} ) = {\sum }_{j} {\sum }_{k} P ( {T}_{i} \vert {X}_{j} , {Y}_{k} ) P ( {X}_{j} ) P ( {Y}_{k} ) \qquad [ Equation 4 ]$$

For example, when P(X₁)=70%, P(X₂)=30%, P(Y₁)=100%, and P (Y₂)=0%, P_{XY}(T)={97%, 0%, 3%} is obtained.

In step S206, the lighting state evaluation unit 131 calculates a divergence degree between the reliability (before update) output from the lighting state determination unit 123 and the reliability (after update) calculated in step S205, thereby evaluating the reliability of the lighting state of the traffic light determined by the lighting state determination unit 123. For the calculation of the divergence degree, for example, the following equation [Equation 5] is used.

$$\frac{1}{n} {\sum }_{i = 1}^{n} \vert {P}_{XY} ( {T}_{i} ) - P ( {T}_{i} ) \vert \qquad [ Equation 5 ]$$

Here, P_{XY}(T) represents the reliability after the update, and P(T) represents the reliability before the update. Further, n is the number of color patterns of the traffic light, and n=3 (three patterns of red, yellow, and green) in the present embodiment. The lighting state evaluation unit 131 outputs the calculated divergence degree to the vehicle control unit 132 as an evaluation result (evaluation value).

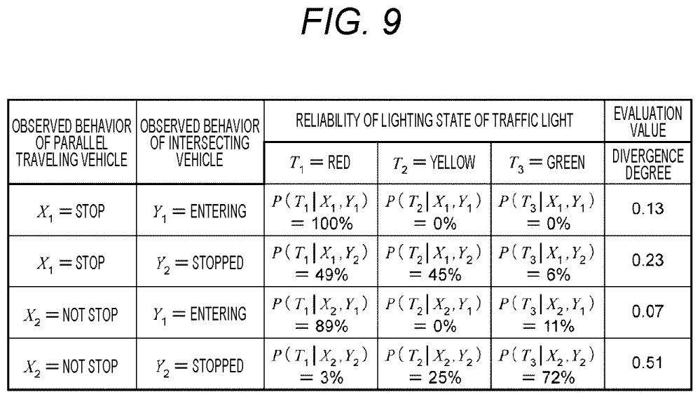

FIG. 9 illustrates an example in which the divergence degree is calculated with respect to the reliability obtained in FIG. 8B. In the case where the possibility of being red has decreased to 3%, “pattern in which a parallel traveling vehicle does not stop before stop line, and an intersecting vehicle stops at stop line”, the divergence degree shows a large value as compared with other patterns. That is, when the divergence degree indicates a large value, it can be said that the lighting state of the traffic light determined by the lighting state determination unit 123 is highly likely to be an error.

In step S207, the vehicle control unit 132 makes a decision related to the driving support function at the intersection where the traffic light is located. The vehicle control unit 132 basically determines the travel contents (control contents) of the vehicle based on (the reliability of) the lighting state of the traffic light determined by the lighting state determination unit 123. At this time, when the divergence degree of the reliability obtained from the lighting state evaluation unit 131 in step S206 is equal to or greater than the reference value, the vehicle control unit 132 determines that the lighting state of the traffic light determined by the lighting state determination unit 123 is an error, and does not activate the driving support function. In a case where the driving support function is already in operation, the driving support function is interrupted, and the driver is notified of the fact, or a shrinking operation for avoiding danger is executed. In addition, in a case where a state in which the divergence degree of the reliability is higher than the reference value continues, it may be regarded that the recognition processing system has failed, and the case may be treated as failure.

As described above, by setting the behavior (prediction) of other vehicles with respect to the lighting state of the traffic light at the intersection in advance as the probability distribution, the reliability of the lighting state of the traffic light obtained from the captured image can be updated based on the behavior of the other vehicles existing around the host vehicle. Further, by evaluating the divergence degree of the reliability before and after the update and interrupting the driving support function or treating the case as failure when the divergence degree indicates a value larger than the reference value, it is possible to prevent the host vehicle from being controlled by executing the driving support function based on the erroneous lighting state even in a scene where the lighting state of the traffic light is erroneously determined.

Although the preferred embodiments of the present invention have been described above, the present invention is not limited to the above-described embodiments at all, and various modifications can be made without departing from the gist of the present invention.

For example, even in a case where the host vehicle determines the lighting state of a pedestrian traffic light, the determination result can be evaluated by the vehicle control system 1 illustrated in FIG. 1. In this case, instead of FIGS. 7A and 7B, a probability distribution table in which the probability of each of the behavior {crossing pedestrian crossing, not crossing pedestrian crossing} of a pedestrian with respect to the lighting state {red, green, green flashing green light} of the pedestrian traffic light is set may be used.

As described above, the vehicle control system 1 of the present embodiment includes the lighting state determination unit 123 which determines a lighting state of a traffic light placed on a road on which a host vehicle travels, and calculates the reliability of the determined lighting state of the traffic light, the dynamic object recognition unit 122 which recognizes information regarding a dynamic object existing around the host vehicle (behavior of another vehicle, a pedestrian, or the like), and the lighting state evaluation unit 131 which updates the reliability of the lighting state calculated by the lighting state determination unit 123 based on the information recognized by the dynamic object recognition unit 122 (information regarding the dynamic object existing around the host vehicle).

The vehicle control system 1 (the vehicle control unit 132) determines the control contents of the host vehicle based on the reliability updated by the lighting state evaluation unit 131.

More specifically, the lighting state evaluation unit 131 calculates a divergence degree between the reliability of the lighting state calculated by the lighting state determination unit 123 and the reliability updated based on the information recognized by the dynamic object recognition unit 122.

The vehicle control system 1 (the vehicle control unit 132) determines the control contents of the host vehicle based on the magnitude of the divergence degree calculated by the lighting state evaluation unit 131.

According to the present embodiment, the determination result of the lighting state of the traffic light obtained from the captured image can be evaluated based on the behavior of the dynamic object existing around the host vehicle. As a result, it is possible to provide the vehicle control system 1 capable of preventing the host vehicle from being controlled according to an erroneous determination result, and ensuring safety even in a case where a captured image contains a large amount of noise and an erroneous lighting state is determined.

Note that the present invention is not limited to the above-described embodiments, and includes various modifications. For example, the above-described embodiments have been described in detail in order to simply describe the present invention, and are not necessarily limited to those having all the described configurations.

In addition, a part or all of the above-described configurations, functions, processors, processing means, and the like may be realized by hardware, for example, by designing with an integrated circuit. In addition, each of the above-described configurations, functions, and the like may be realized by software by a processor interpreting and executing a program for realizing each function. Information such as a program, a table, a file, and the like for realizing each function can be stored in a storage device such as a memory, a hard disk, and a solid state drive (SSD), or a recording medium such as an IC card, an SD card, a DVD, and the like.

In addition, the control lines and the information lines indicate those necessary for the description, and do not necessarily indicate all the control lines and the information lines on the product. In practice, it may be considered that almost all the configurations are connected to each other.

### REFERENCE SIGNS LIST

1 vehicle control system
11 input device
111 host vehicle behavior acquisition unit
112 external environment acquisition unit
113 road information acquisition unit
12 recognition device
121 travel situation recognition unit
122 dynamic object recognition unit
123 lighting state determination unit
13 control device
131 lighting state evaluation unit
132 vehicle control unit
14 output device
141 display
142 sound output device
143 various actuators

1. A vehicle control system comprising:
a lighting state determination unit which determines a lighting state of a traffic light placed on a road on which a host vehicle travels, and calculates reliability of the determined lighting state of the traffic light;
a dynamic object recognition unit which recognizes information regarding a dynamic object existing around the host vehicle; and
a lighting state evaluation unit which updates the reliability of the lighting state calculated by the lighting state determination unit based on the information recognized by the dynamic object recognition unit.

2. The vehicle control system according to claim 1, wherein the dynamic object recognition unit recognizes at least one behavior of a vehicle that is traveling or stops in a lane adjacent to an own lane, a vehicle that is traveling or stops in a lane intersecting the own lane, and a pedestrian existing at an intersection.

3. The vehicle control system according to claim 1, wherein the lighting state determination unit extracts a region of a self-luminous object from a captured image, determines a lighting state of the traffic light and calculates reliability from a proportion of colors included in the region of the self-luminous object.

4. The vehicle control system according to claim 1, wherein the lighting state determination unit determines a lighting state of the traffic light and calculates reliability by inference based on a machine learning method.

5. The vehicle control system according to claim 1, wherein the lighting state evaluation unit updates the reliability of the lighting state using a probability distribution in which behavior prediction of a dynamic object according to a lighting state of a traffic light is expressed by a probability.

6. The vehicle control system according to claim 1, wherein the vehicle control system determines control contents of a host vehicle based on the reliability updated by the lighting state evaluation unit.

7. The vehicle control system according to claim 1, wherein the lighting state evaluation unit calculates a divergence degree between the reliability of the lighting state calculated by the lighting state determination unit and the reliability updated based on the information recognized by the dynamic object recognition unit.

8. The vehicle control system according to claim 7, wherein the vehicle control system determines control contents of a host vehicle based on a magnitude of the divergence degree calculated by the lighting state evaluation unit.
